(19) United States
(12) Patent Application Publication
(10) Pub. No.: US 2014/0039751 A1
(43) Pub. Date: Feb. 6, 2014

(54) CIGARETTE LIGHTER ADAPTER FOR ENGINE STATUS MONITORING

(71) Applicants: Mark K. Hart, Willow Spring, NC (US); Joshua N. Downing, Kansas City, MO (US); Mason A. Prashek, Overland Park, KS (US); Richard V. Gentry, Cary, NC (US)

(72) Inventors: Mark K. Hart, Willow Spring, NC (US); Joshua N. Downing, Kansas City, MO (US); Mason A. Prashek, Overland Park, KS (US); Richard V. Gentry, Cary, NC (US)

(73) Assignee: GARMIN SWITZERLAND GMBH, Schaffhausen (CH)

(21) Appl. No.: 13/567,875

(22) Filed: Aug. 6, 2012

(51) Int. Cl. G06F 19/00

(52) U.S. Cl. 701/33.3

(57) ABSTRACT

A system for determining an idling status of a vehicle having an engine and a cigarette lighter socket may comprise a cigarette lighter adapter, a sensor, and a processor. The cigarette lighter adapter may be inserted in the cigarette lighter socket to sense a battery voltage of the vehicle. The sensor may be used to determine a speed of the vehicle. The processor may be coupled with the cigarette lighter adapter and the sensor. The processor may determine an engine status using the sensed battery voltage and determine a vehicle idling status using the determined engine status and the determined speed.

### BACKGROUND

Embodiments of the present technology relate to vehicle engine status monitoring. An engine status of a vehicle with an engine may include three states—off, starting, and running. Vehicle engines are often left running (or idling) even when their vehicles are parked or otherwise not moving. Excessive engine idling is undesirable as it may contribute to increased fuel costs, air pollution, decreased fuel efficiency, and unnecessary engine wear.

### SUMMARY

Embodiments of the present technology provide a system for determining an idling status of a vehicle engine. The system may broadly comprise a cigarette lighter adapter, a sensor, and a processor. The cigarette lighter adapter may be inserted in a cigarette lighter socket of the vehicle to sense a battery voltage of the vehicle. The sensor may be used to determine a speed of the vehicle. The processor may be coupled with the cigarette lighter adapter and the sensor and may determine an engine status using the sensed battery voltage and may determine if vehicle idling status using the determined engine status and the determined ground speed.

Another embodiment of the system may comprise a cigarette lighter adapter and an electronic device. The cigarette lighter adapter may be inserted in the cigarette lighter socket to sense a battery voltage of the vehicle. The electronic device may couple with the cigarette lighter adapter and may include a sensor and a processor. The sensor may be used to determine a ground speed of the vehicle. The processor may determine an engine status using the sensed battery voltage and determine that the vehicle is idling when the determined engine status is running and the determined ground speed is below a threshold speed.

Embodiments of the present technology may also provide a method for determining an idling status of a vehicle engine. The method may comprise the steps of sensing a battery voltage of the vehicle through a cigarette lighter socket, determining an engine status of the vehicle using the sensed voltage, determining a ground speed of the vehicle, and determining if the vehicle is idling using the determined engine status and the determined ground speed.

This summary is provided to introduce a selection of concepts in a simplified form that are further described below in the detailed description. This summary is not intended to identify key features or essential features of the claimed subject matter, nor is it intended to be used to limit the scope of the claimed subject matter.

Other aspects and advantages of the present technology will be apparent from the following detailed description of the embodiments and the accompanying drawing figures.

BRIEF DESCRIPTION OF THE DRAWING FIGURES

Embodiments of the present technology is described in detail below with reference to the attached drawing figures, wherein:

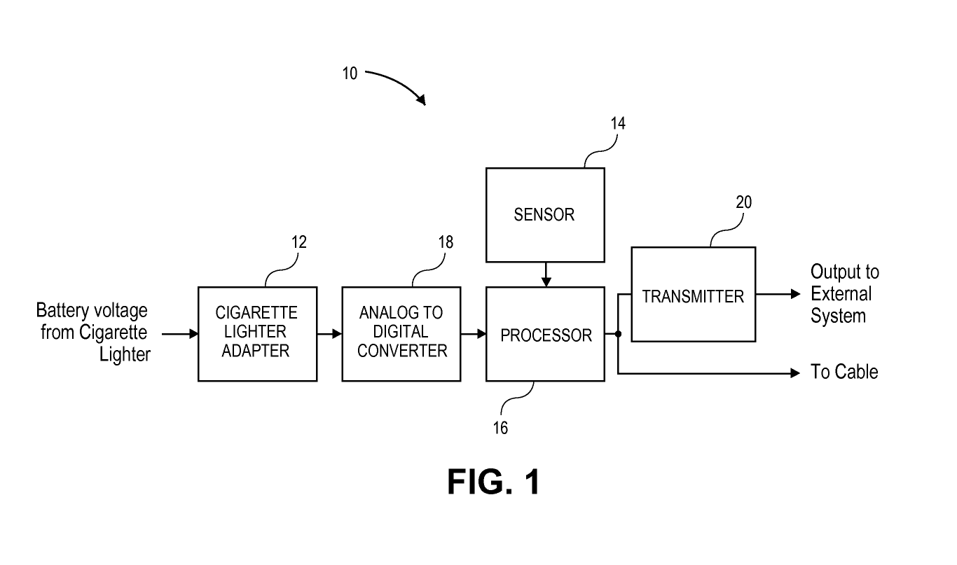

FIG. 1 is a block diagram of a system for determining an idling status of a vehicle constructed in accordance with various embodiments of the present technology;

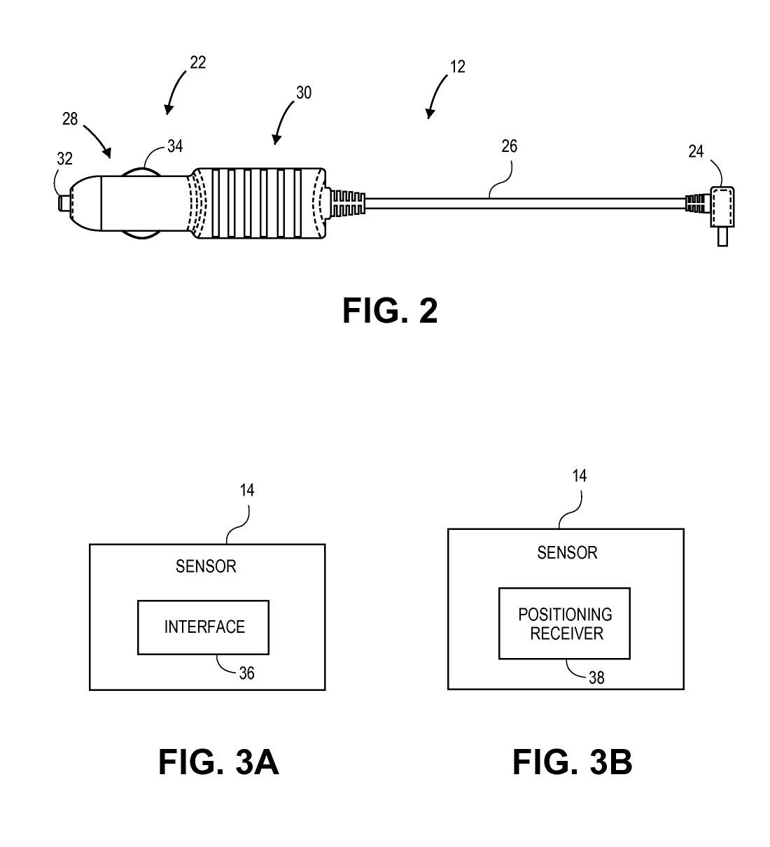

FIG. 2 is a top view of a cigarette lighter adapter portion of the system;

FIG. 3A is a block diagram of an embodiment of a sensor that is part of the system;

FIG. 3B is a block diagram of another embodiment of the sensor;

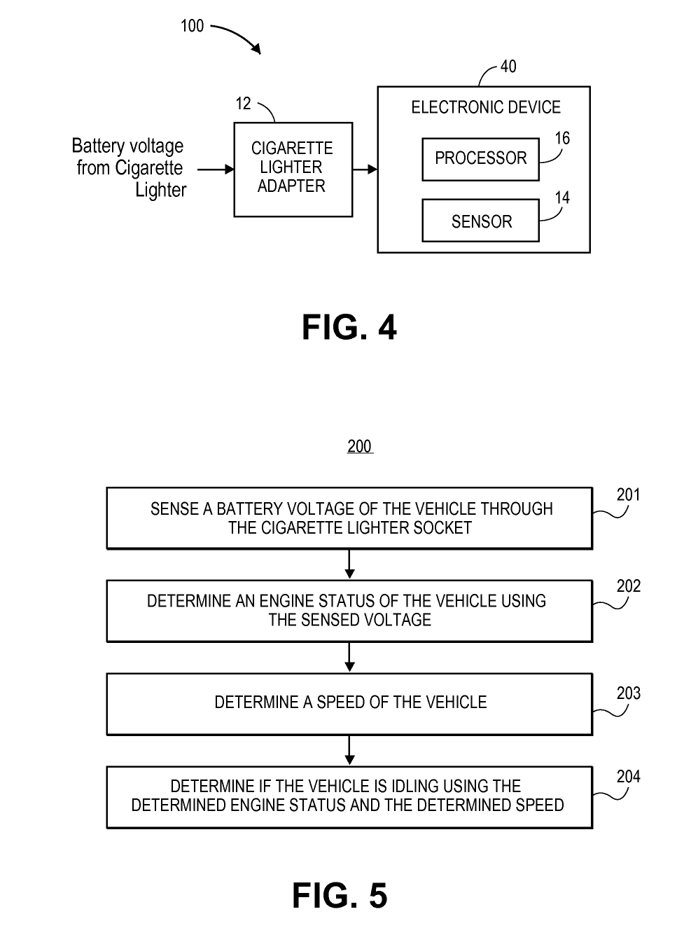

FIG. 4 is a block diagram of a system for determining an idling status of a vehicle constructed in accordance with another embodiment of the present technology; and

FIG. 5 is a flow diagram of at least a portion of the steps of a method for determining an idling status of a vehicle engine.

The drawing figures do not limit the present technology to the specific embodiments disclosed and described herein. The drawings are not necessarily to scale, emphasis instead being placed upon clearly illustrating the principles of the technology.

### DETAILED DESCRIPTION

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the present technology. The following detailed description is, therefore, not to be taken in a limiting sense. The scope of the present technology is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

Various embodiments of the present technology may include a system for determining an idling status of a vehicle engine. The system may be used with any vehicle that includes a gasoline engine, a diesel engine, or other engine including automobiles, vans, trucks, military vehicles, or the like. The vehicle may be part of a fleet of commercial vehicles such as tractor trailer trucks that are used by a shipping company, delivery trucks, passenger vehicles, or the like. A fleet management company may monitor the idling status of its vehicles in order to advise its drivers against excessive idling, such as leaving the engines running while the vehicles are parked. In addition, a navigation device may use the idling status of a vehicle in real time to suggest an alternate route if the idling status indicates that the vehicle is idling frequently. Alternatively, a driver may monitor his vehicle's idling status over time in order to improve fuel efficiency by avoiding routes that historically have resulted in increased idling due to traffic congestion or other delaying activities.

Embodiments of the technology will now be described in more detail with reference to the drawing figures. Referring initially to FIGS. 1 and 2, a system 10 for determining a vehicle engine idling status is illustrated and may broadly comprise a cigarette lighter adapter 12, a sensor 14, and a processor 16. Various embodiments of the technology may also comprise an analog to digital converter 18, and a transmitter 20.

The cigarette lighter adapter 12, as seen in FIG. 2, may be configured to be received in a traditional cigarette lighter socket as is implemented in a vehicle and traditionally located in the dashboard, the center console, or other area generally accessible by the driver of the vehicle. The cigarette lighter adapter 12 broadly includes a socket coupler 22, a connector 24, and a cable 26 connecting the socket coupler 22 and the connector 24.

The socket coupler 22 may include a tip 28, a body 30, a pin 32, and a ground contact 34. The tip 28 is the portion of the cigarette lighter adapter 12 that is inserted into the cigarette lighter socket. The tip 28 may have a cylindrical shape with an outer diameter that is slightly less than the inner diameter of the cigarette lighter socket. The tip 28 may further include a generally hemispherical head at a forward end with an opening to accommodate the pin 32.

The body 30 may be coupled to or integrally formed with the cylindrical portion of the tip 28 and may have a generally rectangular box shape. The body 30 may include peripheral grooves, contours, or other features that make it easier to grip. The body 30 is typically handled by the user when the cigarette lighter adapter 12 is inserted into the cigarette lighter socket. The tip 28 and/or the body 30 may further include an internal cavity that is not shown in the figures. The cavity may retain other components of the system 10, as discussed below.

The pin 32 may be positioned within the opening of the tip 28 and may extend therefrom. When the cigarette lighter adapter 12 is positioned in the cigarette lighter socket, the pin 32 makes an electrical connection with an electrode of the socket that receives a voltage from the vehicle battery. The pin 32 may be of elongated cylindrical shape and manufactured from electrically conductive material, typically metal. Generally, the voltage is taken from the positive terminal of the battery and is considered to be the battery's voltage. Thus, the pin 32 receives an electrical signal representative of the battery voltage when the cigarette lighter adapter 12 is positioned in the cigarette lighter socket.

The ground contact 34 may include one or more electrically conductive wires that are longitudinally aligned and extend from the cylindrical portion of the tip 28. The ground contact 34 wires may be arc shaped and may have a mechanical resiliency that produces a spring-like reaction when the ground contact 34 is pushed inward toward the center of the tip 28. Thus, the ground contact 34 pushes outward against the cigarette lighter socket to provide a tight fit when the cigarette lighter adapter 12 is positioned therein. Furthermore, when the cigarette lighter adapter 12 is positioned in the cigarette lighter socket, the ground contact 34 receives the electrical ground from the negative terminal of the vehicle's battery.

The cable 26 may include one or more insulated conductive elements, such as wires, that are encapsulated by a nonconductive jacket. One end of the cable 26 may be coupled to the body 30 of the cigarette lighter adapter 12. The other end of the cable 26 may be coupled with a connector 24. The connector 24 may also include conductive elements such as pins. The connector 24 may fit into a similarly shaped receptacle on an electronic device. An exemplary connector 24 may be a mini-B connector. The cable 26 may provide the battery voltage and electrical ground as well as data signals.

The sensor 14 may sense movement of the vehicle and be used to determine a speed of the vehicle. The processor 16 may access the sensor 14 to determine the speed of the vehicle and/or the sensor 14 may independently determine the speed of the vehicle. The sensor 14 may provide a signal or data representative of speed, position, location, and/or other movement data to the processor 16. In various embodiments, the sensor 14 may be housed within the cigarette lighter adapter 12, the processor 16, or other components of the system 10.

In some embodiments, the sensor 14 may include an interface 36, as shown in FIG. 3A, which can couple with a vehicle system that provides communication and status information from electronic components of the vehicle. The vehicle communication system may also be considered a data bus for the vehicle's electronic components. An example of the vehicle communication system is the on-board diagnostics (OBDII) standard of vehicle electronic communication. Typically, the vehicle includes a connector in or around the dashboard that connects to the communication system. Once coupled to the vehicle communication system, one or more vehicle processors may be accessed to retrieve information regarding the subsystems of the vehicle, such as the engine or the drivetrain. Accordingly, the interface 36 may include serial and/or parallel transceiving circuits, data or signal processing circuits, and data storage circuits. The interface 36 may couple with the vehicle communication system to retrieve the vehicle speed and may store the speed, at least temporarily, for use by the processor 16.

In other embodiments, the sensor 14 may include a positioning receiver 38, as shown in FIG. 3B, to determine the position and/or speed of the vehicle. An example of the positioning receiver 38 is a global positioning system (GPS) receiver. The positioning receiver 38 may receive a signal from satellites and/or terrestrial-based transmitters from which the global position of the vehicle can be derived. Given the change in the position of the vehicle over time, the speed of the vehicle can be determined. Thus, the positioning receiver 38 may also include data or signal processing circuits, and data storage circuits. In some configurations, the positioning receiver 38 or portions thereof may be integrated with the processor 16.

The processor 16 may include microprocessors, microcontrollers, digital signal processors (DSPs), field-programmable gate arrays (FPGAs), application-specific integrated circuits (ASICs), and the like, or combinations thereof. The processor 16 may further include, or may be in communication with, a data storage component such as read-only memory (ROM), random-access memory (RAM), hard-disk drives, optical disk drives, flash memory drives, and the like, or combinations thereof. The data storage component may include, or may constitute, a “computer-readable medium”. In various embodiments, the processor 16 and the data storage component may be housed within the cigarette lighter adapter 12.

The processor 16 may receive data or signals representative of the voltage from the vehicle battery through the cigarette lighter adapter 12—specifically from the pin 32. Typically, when the engine is not running, the voltage from the battery is at a first level. An exemplary first level is approximately 12 volts (V). When the engine is started, the voltage from the battery may decrease momentarily and then may rise to a second level that is greater than the first level, due to the engine running and charging the battery. An exemplary second level is approximately 14 V. When the voltage from the battery rises to the second level, the processor 16 may determine that the engine is running. Thus, the processor 16 may determine whether the engine is off, starting, or running. The values of the first level and the second level may vary based on a number of conditions such as the age of the battery, the battery temperature, and the state of charge of the battery. In addition, the charging of the battery by the engine may vary when there is a load on the engine. Furthermore, any of these parameters may vary based on the manufacturer and make of the vehicle. As a result, the processor 16 may dynamically adapt the values of the first level and the second level when the processor 16 is determining whether the engine is off, starting, or running.

The processor 16 may receive data or signals representative of the speed and/or position of the vehicle from the positioning receiver 38. The ground speed may be indicated in units of miles per hour, kilometers per hour, or other units of measure. If the processor 16 determines that the engine is running and that the speed is below a threshold, then the processor 16 may determine that the vehicle is idling. The threshold may be a very low ground speed, such as 3 miles per hour. At this ground speed and below, the engine is less efficient, with regard to fuel consumption, than at higher ground speeds. Additionally, if the vehicle is stopped and the ground speed is zero, then the processor 16 may determine that the vehicle is idling.

The processor 16 may determine a vehicle idling status utilizing data provided by the positioning receiver 38, the cigarette lighter adapter 12, the sensor 14, and/or other components of the system 10. In some configurations, the vehicle idling status may include an idle time determination or idling determination. In other configurations, the vehicle idling status may include engine on and off times, vehicle start movement times, and vehicle stop movement times. The processor 16, and/or an external system such as a fleet management system, may utilize the vehicle idling status to determine various idling information including idle time.

The processor 16 may provide an idling signal that indicates the vehicle idling status, such as whether the vehicle is idling or not. The idling signal may additionally or alternatively indicate other vehicle idling status information such as engine on and off times and vehicle movement times. When the engine is not running and/or the speed is greater than the threshold, the idling signal may indicate that the vehicle is not idling. The idling signal may include text and/or numerical values, or, in some embodiments, may be binary or digital value with a first state indicating that the vehicle is not idling and a second state that indicates that the vehicle is idling. In various embodiments, the processor 16 may also include timers, or similar components, to track the amount of time that the vehicle is idling. The idling signal may also include the amount of idle time, the speed of the vehicle, and/or other data assembled by the processor 16.

The analog to digital converter (ADC) 18 may provide a digital or binary value that represents an analog voltage coupled to the ADC 18. The ADC 18 may include electronic circuitry as is known in the art such as operational amplifiers, comparators, counters, timers, and the like, or combinations thereof. The ADC 18 may receive the voltage from the battery through the pin 32 and may convert the voltage to a digital signal that represents the value of the voltage. The digital signal may be serial or parallel. In various embodiments, the ADC 18 may be housed within the cigarette lighter adapter 12. In some embodiments, the ADC 18 or similar analog voltage sensing functionality may be included in the processor 16.

The transmitter 20 may include circuitry to transmit data and/or signals wirelessly. The transmitter 20 may transmit in the radio frequency (RF) spectrum and may include amplifiers and one or more antennas, as are known in the art. The transmitter 20 may transmit using Bluetooth® or similar communication standards. In some configurations, the transmitter 20 is a cellular modem operable to transmit data through a cellular network. The transmitter 20 may receive the idling signal from the processor 16 and may transmit it to external systems. In various embodiments, the transmitter 20 may be housed within the cigarette lighter adapter 12. Furthermore, the cable 26 may include an antenna.

The system 10 may operate as follows. The socket coupler 22 of the cigarette lighter adapter 12 may be plugged into a cigarette lighter socket in a vehicle. The pin 32 may receive an electrical signal representative of the voltage from the battery. The ADC 18 may convert the voltage to a digital signal that represents the voltage value and may provide the digital signal to the processor 16. If the value of the battery voltage is at the first level, then the processor 16 may determine that the engine is not running. If the value of the battery voltage is at the second level, then the processor 16 may determine that the engine is running. If the value of the battery voltage is between the first level and the second level, then the processor 16 may determine that the engine is starting.

The sensor 14 may sense the speed of the vehicle from either the interface 36 coupled to the vehicle communication system, the positioning receiver 38, and/or other components. The processor 16 may receive data or signals representative the vehicle ground speed from the sensor 14. In some configurations, the processor 16 may calculate speed based on speed data, such as position or location, provided by the sensor 14. If the ground speed is zero, or less than a threshold like 3 MPH, and the engine is running, then the processor 16 may determine that the vehicle is idling and the idling signal may be set to idling. Otherwise, the idling signal is set to not idling. The processor 16 may provide the idling signal to the cable 26, which in turn, may communicate the idling signal to an electronic device, such as a navigational device or the like. If the navigational device determines that the vehicle is on a road or highway and is idling, then the navigational device may determine that there is traffic congestion and may suggest an alternate route to avoid the congestion.

If the system 10 includes the transmitter 20, then the processor 16 may also provide the idling signal to the transmitter 20, which in turn, may communicate the signal to an external system such as a fleet management center that collects data on fleet associated vehicles. The transmitter 20 may also communicate the idling signal to a device such as a cell phone, a laptop computer, a tablet, or the like. These types of devices may be executing or running an application, or app, which provides navigational service. As discussed above with the navigational device, the app may suggest alternate routes if it determines that there is traffic congestion.

For example, in some configurations, the sensor 14 and processor 16 may be disposed within the housing of the cigarette lighter adapter 12. By functioning as described above, the processor 16 may determine if the vehicle engine is idling. The engine idling status may be provided to a separate electronic device, like a tablet, mobile phone, navigation device, laptop computer, or the like. The cigarette lighter adapter 12 and the separate electronic device may be coupled using a cable extending from the cigarette lighter adapter 12, which is operable to provide data including the engine idling status to the separate electronic device. Additionally, the cable may be operable to provide power, communication, and other signals to the separate electronic device. That is, the cigarette lighter adapter 12 may provide conventional power functionality to the separate electronic device in addition to the idling functionality described herein. Instead of or in addition to the cable, the cigarette lighter adapter 12 may wirelessly couple with the separate electronic device to transmit idling information thereto using the transmitter 20. An application or app running on the separate electronic device may utilize the idling information for various logging, maintenance, tracking, and navigation purposes. The separate electronic device may include a cellular modem or other transmitter device to transmit the received idling information, or other information associated with the vehicle such as the vehicle idling status information, to a remote computer, such as a server maintained by a fleet management service or a web site utilized for vehicle tracking purposes.

In another embodiment shown in FIG. 4, a system 100 for determining a vehicle idling status of a vehicle may include the cigarette lighter adapter 12 and an electronic device 40. The cigarette lighter adapter 12 may be substantially the same as described above. The pin 32 of the cigarette lighter adapter 12 may couple with one of the conductive elements of the cable 26 to determine battery voltage as described above.

The electronic device 40 may include the sensor 14 and the processor 16 as described above. The electronic device 40 may also include the ADC 18. An example of the electronic device 40 may be a navigation device, a cell phone, a tablet, a notebook computer, a laptop computer, a media device, a vehicle computer, and/or the like.

The system 100 may operate as follows. The socket coupler 22 of the cigarette lighter adapter 12 may be plugged into a cigarette lighter socket in a vehicle. The pin 32 may receive a signal representative of the voltage from the battery. The cable 26 may be connected to the electronic device 40 so that the ADC 18 may receive the battery voltage. The ADC 18 may convert the voltage to the digital binary signal and provide the digital binary signal to the processor 16. Given the digital binary signal, the processor 16 may determine the engine status, as discussed above. The processor 16 may determine the speed using the sensor 14. The processor 16 may then determine the vehicle idling status, as described above. The electronic device 40 may also include the transmitter 20 and may transmit the vehicle idling status to external systems such as a fleet management server. In some configurations, the vehicle idling status may include information such as engine status (engine on, engine off) and start and stop times for vehicle movement. The fleet management system may calculate idle time based on this, and/or other, vehicle idling status information. The electronic device 40 may include navigational functionality that utilizes the vehicle idling status to suggest alternate routes of travel.

At least a portion of the steps of a method 200, in accordance with various aspects of the present technology, for determining a vehicle idling status is shown in FIG. 5. The steps of the method 200 may be performed in the order as shown in FIG. 5, or they may be performed in a different order. Furthermore, some steps may be performed concurrently as opposed to sequentially. In addition, some steps may not be performed.

Referring to step 201, a battery voltage of the vehicle is sensed through a cigarette lighter socket. A cigarette lighter adapter 12 may be inserted into the cigarette lighter socket. The cigarette lighter adapter 12 may include a pin 32 that contacts the battery connection to the cigarette lighter socket. The pin 32 may couple to an analog to digital converter (ADC) 18 which receives the battery voltage and converts it to a digital binary signal which represents the value of the voltage. The ADC 18 may provide the digital binary signal to a processor 16.

Referring to step 202, an engine status of the vehicle is determined using the sensed battery voltage. The processor 16 may determine the engine status from the digital binary signal which is derived from the sensed battery voltage. Typically, when the engine is off, or not running, the battery voltage, and in turn the digital binary signal, is at a first level. When the engine is running, the battery voltage is at a second level, greater than the first level. When the engine is starting, the battery voltage is momentarily in between the first level and the second level. Thus, the processor 16 may determine if the engine is off, starting, or running.

Referring to step 203, a ground speed of the vehicle is determined. The processor 16 determines the speed using data provided by the sensor 14, such as speed or position data. In some embodiments, the sensor 14 may include an interface 36 operable to couple with a vehicle communication system. The interface 36 may retrieve status information from the processing system of the vehicle that includes the ground speed of the vehicle. In other embodiments, the sensor 14 may include a positioning receiver 38, such as a global positioning system (GPS) receiver, which receives location information regarding the vehicle. From the location information, the positioning receiver 38 may determine the ground speed of the vehicle.

Referring to step 204, it is determined if the vehicle is idling using the determined engine status and the determined ground speed. Using the ground speed and the engine status, determined in step 202, the processor 16 may determine the vehicle idling status. If the ground speed is below a threshold, and/or at or near zero, and the engine status is running, then the vehicle idling status is idling. If the ground speed is greater than the threshold and/or the engine is not running, then the vehicle idling status is not idling.

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

What is claimed is:

1. A system for determining an idling status of a vehicle having an engine and a cigarette lighter socket, the system comprising:
a cigarette lighter adapter operable to be inserted in the cigarette lighter socket to sense a battery voltage of the vehicle;
a sensor operable to sense movement of the vehicle; and
a processor coupled with the cigarette lighter adapter and the sensor, the processor operable to:
determine a speed of the vehicle using information provided by the sensor;
determine an engine status using the sensed battery voltage, and
determine a vehicle idling status using the determined engine status and the determined speed.

2. The system of claim 1, wherein the sensor includes a global positioning receiver.

3. The system of claim 1, wherein the sensor includes an interface operable to access a data bus of the vehicle to acquire vehicle movement information.

4. The system of claim 1, wherein the sensor is integral with the cigarette lighter adapter.

5. The system of claim 1, wherein the processor is a remote server outside of the vehicle and the sensor is operable to wirelessly communicate with the processor.

6. The system of claim 1, wherein the engine status has one of three states including a running state, a starting state, and an off state.

7. The system of claim 6, wherein the processor determines that the vehicle is idling if the engine status is running and the determined speed is below a threshold.

8. The system of claim 1, further comprising a transmitter operable to wirelessly transmit the vehicle idling status to an external system.

9. The system of claim 1, wherein the sensor and processor are integral.

10. The system of claim 1, further comprising a cable operable to communicate the vehicle idling status, the cable including a connector operable to couple with an electronic device.

11. A method for determining an idling status of a vehicle having an engine and a cigarette lighter socket, the method comprising the steps of:
sensing a battery voltage of the vehicle through the cigarette lighter socket;
determining an engine status of the vehicle using the sensed voltage;
determining a speed of the vehicle; and
determining a vehicle idling status using the determined engine status and the determined speed.

12. The method of claim 11, wherein the engine status has one of three states including a running state, a starting state, and an off state.

13. The method of claim 12, wherein the vehicle is determined to be idling if the engine status is running and the determined speed is below a threshold.

14. The method of claim 11, wherein determining the speed of the vehicle includes receiving the speed from a data bus of the vehicle.

15. The method of claim 11, wherein determining the speed of the vehicle includes receiving the speed from a global positioning receiver.

16. A system for determining an idling status of a vehicle having an engine and a cigarette lighter socket, the system comprising:
a cigarette lighter adapter operable to be inserted in the cigarette lighter socket to sense a battery voltage of the vehicle; and
an electronic device operable to couple with the cigarette lighter adapter, the electronic device including a processor and a sensor operable to sense movement of the vehicle, wherein the processor is operable to:
determine a speed of the vehicle using information provided by the sensor;
determine an engine status using the sensed battery voltage of the vehicle, wherein the engine status includes a first state of running, and
determine that the vehicle is idling when the determined engine status is running and the determined speed is below a threshold.

17. The system of claim 16, wherein the sensor includes a global positioning receiver.

18. The system of claim 16, wherein the sensor is operable to access a data bus of the vehicle to determine the speed of the vehicle.

19. The system of claim 16, wherein the cigarette lighter adapter includes a cable with a connector operable to couple with the electronic device, the cable operable to communicate the battery voltage.

20. The system of claim 16, wherein the processor is operable to determine the speed of the vehicle using position data provided by the sensor.
